(19) United States
(12) Patent Application Publication
(10) Pub. No.: US 2005/0039129 A1
(43) Pub. Date: Feb. 17, 2005

(54) Presentation management system and method

(76) Inventor: Chris Paul, Lincoln, MA (US)

Correspondence Address: MCDERMOTT, WILL & EMERY;ATTN: INTELLECTUAL PROPERTY DEPT., 28 STATE STREET, BOSTON, MA, 02109, US

(21) Appl. No.: 10/889,867

(22) Filed: Jul. 13, 2004

Related U.S. Application Data
(63) Continuation-in-part of application No. 10/052,154, filed on Jan. 16, 2002.
(60) Provisional application No. 60/262,127, filed on Jan. 16, 2001.

(51) Int. Cl. G09G 5/00

(52) U.S. Cl. 715/730; 715/732; 715/727; 715/731

(57) ABSTRACT

An online presentation authoring method includes: allowing a primary author to perform a primary set of tasks concerning an online presentation, and requesting that a guest author perform a secondary set of tasks concerning the online presentation. The guest author is prohibited from performing a portion of the primary set of tasks concerning the online presentation.

### RELATED APPLICATIONS

This application is a Continuation-in-Part of pending U.S. patent application Ser. No. 10/052,154, filed Jan. 16, 2002 and entitled “Method of and System for Composing, Delivering, Viewing and Managing Audio-Visual Presentations over a Communications Network”, which claims the priority of U.S. Provisional Patent Application Ser. No. 60/262,127, filed Jan. 16, 2001.

### FIELD OF THE INVENTION

This invention generally relates to presentation management systems and, more particularly, to presentation management systems that allow for the distributed creation of presentations.

### BACKGROUND

Due to today's fast-paced global economy, the standard practices associated with distributing business information are rapidly being antiquated. For example, a product manager in the past would traditionally have a face-to-face meeting with their product sales team and/or product manufacturing team. Traditionally, these people all worked in a common location, or at facilities that are relatively close by. However, due to the continued globalization of the economy, products are often designed in a first country and manufactured in a second country. Further, sales teams and distributorships may be located in several different countries. Accordingly, for various reasons (e.g., dispersed geographic locations, variations in time zones, and variations in national/regional holidays, for example), it is often difficult (if not impossible) to arrange face-to-face meetings.

The Internet has evolved into a tool that allows for network-based meetings/presentations that can be viewed at remote locations. For example, NetMeeting™ or LiveMeeting™ by Microsoft™ or WebEx™ are tools that allows for web-based meetings in which documents can be shared and modified. Unfortunately, all meeting attendees must be simultaneously available in order for the web-based meeting to occur. Some service providers (e.g., Brainshark™ of Burlington, Mass.) allow users to author “on-demand” presentations that can be viewed at a later date, thus reducing the problems associated with varying time zones and attendee availability.

### SUMMARY OF THE INVENTION

According to an aspect of this invention, an online presentation authoring method includes: allowing a primary author to perform a primary set of tasks concerning an online presentation, and requesting that a guest author perform a secondary set of tasks concerning the online presentation. The guest author is prohibited from performing a portion of the primary set of tasks concerning the online presentation.

One or more of the following features may also be included. The guest author may be two or more guest authors, and requesting that a guest author perform a secondary set of tasks may include: requesting that a first guest author perform a first portion of the secondary set of tasks, and requesting that a second guest author perform a second portion of the secondary set of tasks. The first guest author may be prohibited from performing a portion of the second portion of the secondary set of tasks, and the second guest author may be prohibited from performing a portion of the first portion of the secondary set of tasks.

A message (e.g., an email) inviting the guest author to perform the secondary set of tasks may be authored. The message may include a link that directs the guest author to a screen display that facilitates the guest author completing the secondary set of tasks. The secondary set of tasks may include uploading one or more presentation files, and the link may direct the guest author to a screen display that facilitates the guest author uploading the presentation files. The secondary set of tasks may include providing audio narration clips, and the link may direct the guest author to a screen display that provides the guest author with pertinent information that facilitates the guest author providing the audio narration clips. The guest author may be allowed to provide the audio narration clips using a standard telephony device.

The guest author may complete the secondary set of tasks, and the primary author may be allowed to review and/or edit the secondary set of tasks completed by the guest author. The guest author may complete the secondary set of tasks, and the primary author may be required to review and/or approve the secondary set of tasks prior to the online presentation being made available for viewing. Control of the completed online presentation may be granted to the guest author once the secondary set of tasks is completed. Whether the primary author can request that the guest author perform the secondary set of tasks may be regulated. The guest author may be required to provide a username and/or password prior to performing the secondary set of tasks.

The primary set of tasks may be chosen from the group consisting of: defining a presentation name; defining one or more presentation keywords; defining whether a view receipt email is required; defining whether a viewer of the online presentation is required to provide a username and/or password; defining whether the online presentation is password protected; defining whether the online presentation is downloadable; defining an expiration date for the online presentation; defining the availability of attachments; defining the availability of a guest book; and defining the availability of a FAQ section.

According to another aspect of this invention, an online presentation authoring method includes allowing a primary author to generate a primary portion of an online presentation, and requesting that a guest author generate a secondary portion of the online presentation. The guest author is prohibited from generating the primary portion of the online presentation.

The above-described methods may also be implemented as a sequence of instructions executed by a processor.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a block diagram of a system including a presentation management system;

FIG. 2 is a detailed block diagram of the presentation management system of FIG. 1;

FIG. 3 is a flow chart of a method of preparing an online presentation using the presentation management system of FIG. 1;

FIG. 4a is a screen shot of the upper portion of the “Edit Presentation Data” screen of the presentation management system of FIG. 1;

FIG. 4b is a screen shot of the lower portion of the “Edit Presentation Data” screen of the presentation management system of FIG. 1;

FIG. 5 is a flow chart of a method of recording audio narration clips using the presentation management system of FIG. 1;

FIG. 6a is a screen shot of the upper portion of the “Record Audio for Presentation” screen of the presentation management system of FIG. 1;

FIG. 6b is a screen shot of the lower portion of the “Record Audio for Presentation” screen of the presentation management system of FIG. 1;

FIG. 7 is a screen shot of the “Send Guest Author Audio Request” screen of the presentation management system of FIG. 1;

FIG. 8 is a screen shot of the “Send Guest Author Create Request” screen of the presentation management system of FIG. 1;

FIG. 9 is a screen shot of the “Upload Presentation” screen of the presentation management system of FIG. 1;

FIG. 10 is a screen shot of the “Add Your Audio” screen of the presentation management system of FIG. 1;

FIG. 11 is a screen shot of the “Set Campaign Name and Launch Date” screen of the presentation management system of FIG. 1;

FIG. 12 is a screen shot of the “Set Advanced Customization” screen of the presentation management system of FIG. 1;

FIG. 13 is a screen shot of the “Upload Presentation” screen of the presentation management system of FIG. 1;

FIG. 14 is a screen shot of the “Request Core Audio” screen of the presentation management system of FIG. 1;

FIG. 15 is a screen shot of the “Manage Audio Requests” screen of the presentation management system of FIG. 1;

FIG. 16 is a screen shot of the “Merge Presentations” screen of the presentation management system of FIG. 1;

FIG. 17 is a flow chart of a method of viewing a presentation using the presentation management system of FIG. 1; and

FIG. 18 is a screen shot of the presentation viewing screen of the presentation management system of FIG. 1.

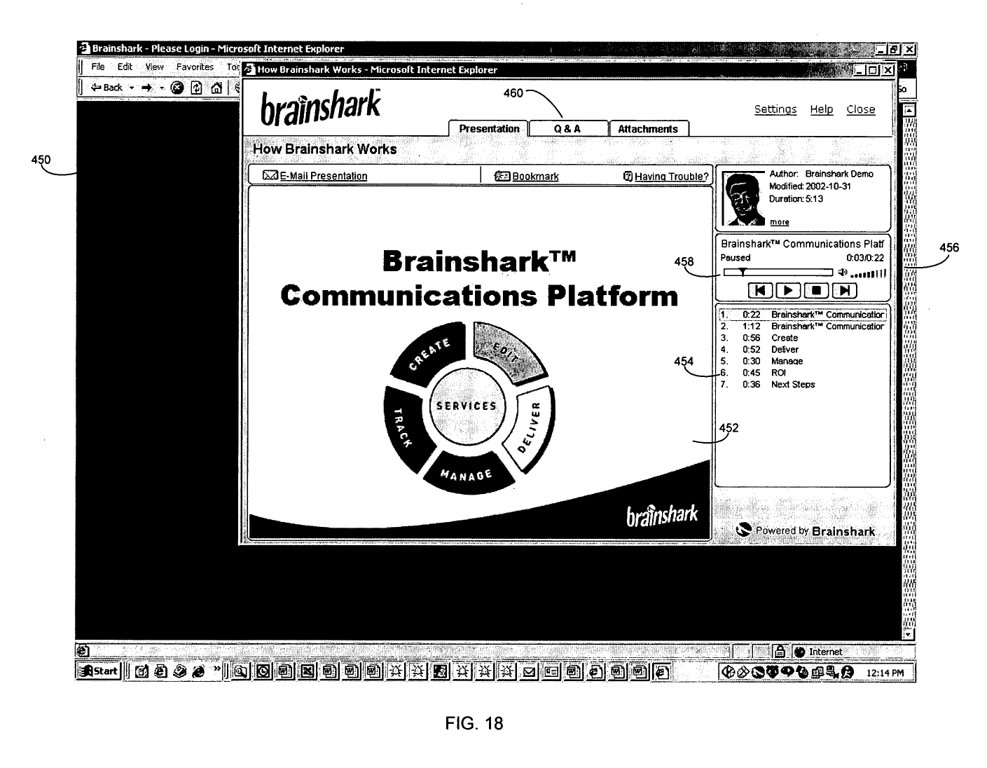

### DETAILED DESCRIPTION OF THE PREFERRED EMBODIMENTS

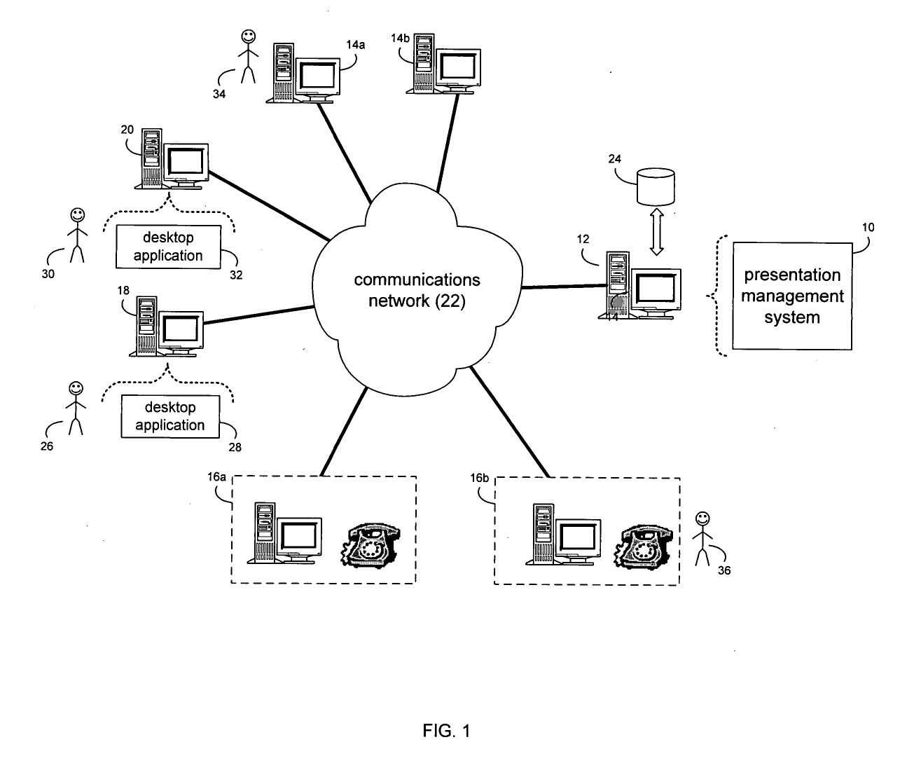

Referring to FIG. 1, there is shown a presentation management system 10 for authoring, delivering, viewing and managing audio-visual presentations over a communications network. Presentation management system 10 includes host system 12, one or more viewer systems 14a,14b, one or more composer systems 16a, 16b, a system administration system 18 and a company administration system 20, all connected to a common communications network 22. While two viewer systems 14a, 14b and two composer systems 16a, 16b are shown, this is for illustrative purpose only and the number of viewer systems 14a, 14b and composer systems 16a, 16b may be varied based on need/application.

Presentation management system 10 typically resides on and is executed by one or more computing systems (e.g., host system 12, viewer systems 14a, 14b, and/or composer systems 16a, 16b) connected to network 22 (e.g., a local area network, a wide area network, an intranet, the internet, a wireless network, or some other form of network). The instruction sets and subroutines of presentation management system 10 are typically stored on a storage device connected to one or more of the computing systems (e.g., storage device 24 connected to host system 12).

Storage device 24 may be, for example, a hard disk drive, a tape drive, an optical drive, a RAID array, a random access memory (RAM), or a read-only memory (ROM). A system administrator 26 typically configures, accesses, and administers presentation management system 10 through a desktop application 28 (e.g., Microsoft Internet Explorer™, Netscape Navigator™, or a specialized user interface) running on system administration system 18. Further, a company administrator 30 may locally configure, access, and administer a portion of presentation management system 10 through a desktop application 32 (e.g., Microsoft Internet Explorer™, Netscape Navigator™, or a specialized user interface) running on company administration system 20.

Host system 12, user systems 14a, 14b, composer systems 16a, 16b, system administration system 18 and company administration system 20 are each typically a personal computer (e.g., such as an IBM PC or IBM PC compatible system), although a mini/mainframe computer system may be used. Composer systems 16a, 16b may also include a standard telephone, which is separately connectable to host system 12 via standard telephone lines. Additionally, viewer systems 14a, 14b, composer systems 16a, 16b, system administration system 18, and company administration system 20 may execute a windowing operating system (e.g., Microsoft Windows™, or Linux, for example), and host system 12 may be configured as a web server, executing a network operating system (e.g., Windows NT Server™) and web server software (e.g., Windows Internet Information Server™), thus allowing host system 12 to host/serve webpages in HyperText Markup Language (i.e., HTML), via a protocol such as the HyperText Transport Protocol (i.e., HTTP).

In addition to web services, host system 12 also includes streaming media services/servers and Interactive Voice Response (i.e., IVR) services/servers. In addition to HTTP web servers, streaming media servers may use different protocols (e.g., MMS and RTSP), in addition to HTTP to stream audio & video media. Viewer systems 14a, 14b, composer systems 16a, 16b, system administration system 18, and/or company administration system 20 typically include software to allow viewing of webpages (e.g., Microsoft™ Internet Explorer) that allows for the viewing of webpages hosted/served by host system 12. Further, viewer systems 14a, 14b, composer systems 16a, 16b, system administration system 18, and/or company administration system 20 may be any wired or wireless communication device that is connectable to network 22, such as an interactive television system (e.g., WEBTV™), a personal digital assistant (i.e., PDA), or a data-enabled cellular telephone.

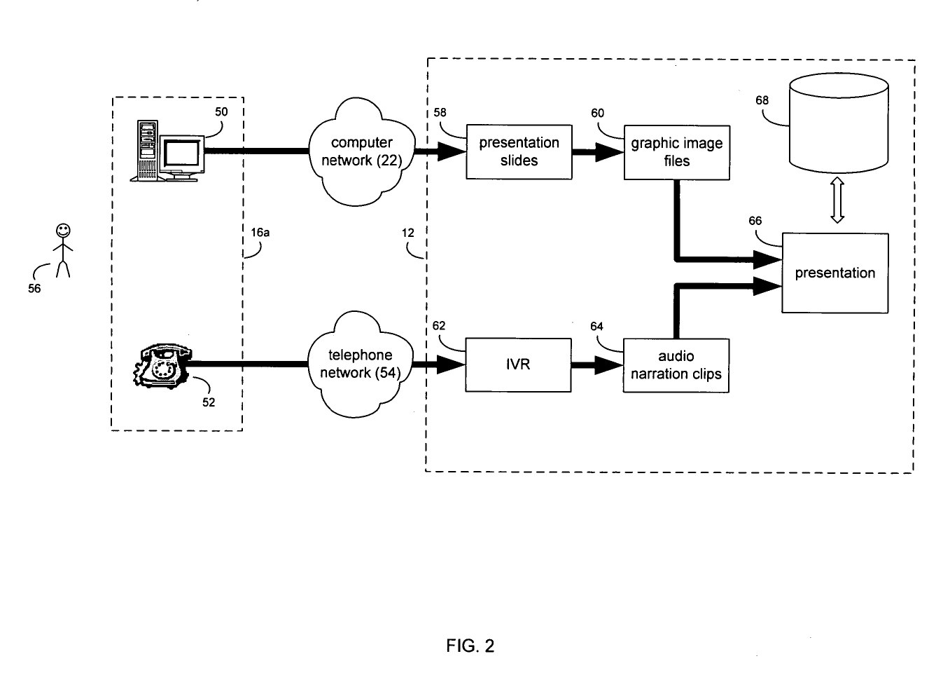

Referring to FIG. 2, composer system 16a includes a computer 50, which is connectable to the host system 12 via network 22 for the purpose of sending and receiving data to and from host system 12. Composer system 16a also includes a telephone 52, which is also connectable to the host system 12 (via public switched telephone network 54) for the purpose of sending and receiving voice signals to and from host system 12. Alternatively, pre-recorded audio can be uploaded (via network 12) from composer system 16a to host system 12.

User 56 may use composer system 16a to generate presentations slides 58 using any of a variety of applications, such as Adobe™ Acrobat™ and Microsoft™ Powerpoint™, Word™, Excel™, or Visio™, for example. Presentation slides 58 may includes text, graphics, photographs, animations, and/or any other form of visual data that enable user 56 to describe the subject matter of the presentation being prepared. Once a group of slides is generated, each slide is assigned a slide title and the group of slides (i.e., a presentation) is saved in the memory of computer 50 under a unique presentation name.

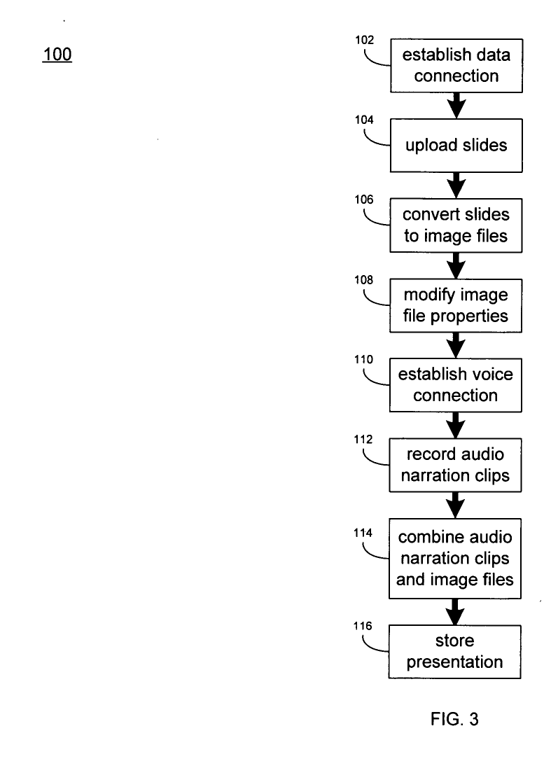

Referring also to FIG. 3, there is shown a method 100 of composing a presentation. Composer system 16a, when used by user 56, establishes 102 a connection between the computer 30 and host system 12 via network 22. Host system 12 provides composer system 16a with a webpage that provides user 56 with several options (e.g., composing a presentation, editing a presentation, and publishing a presentation, for example). If user 56 selects the “compose” option, host system 12 serves a webpage to user 56 that prompts user 56 to provide the filename of the slideshow to be used to compose the presentation. Once the composer provides the filename, the group of presentation slides 58 (or other file type) is uploaded 104 to host system 12 via network 22.

Alternatively, user 56 may choose to select a single slide “template” presentation provided by host system 12, which eliminates the need to upload files to host system 12. These templates allow user 56 to enter text onto a default template slide, select a font, and continue the design process as if user 56 had uploaded a single slide presentation.

Upon receiving the uploaded content (e.g., presentation slides 58), host system 12 converts 106 each slide into a graphic image file 60 that is capable of being easily transmitted over the internet and displayed on one of the viewer systems (e.g., viewer system 14a). Host system 12 saves each graphic image file in a file directory, where each file is identified by its title and assigned a number according to the order in which the file was received by host system 12. Host system 12 typically extracts the title of each slide and stores each slide title in a database for later use (i.e., during playback of the presentation) in an active table-of-contents. The active table-of-contents is selectable by the viewer 34 of the presentation and allows the viewer 34 to navigate from slide to slide during playback of the presentation (as described below in greater detail).

Host system 12 typically transmits a confirmation screen to computer 50 to inform user 56 that the presentation slides have been successfully received and converted to graphic image files. In order to enable user 56 to add an audio portion to the presentation (as described below in greater detail), host system 12 generates a Presentation Edit Session Identifier (PESI), which is used by user 56 to identify the presentation to be modified.

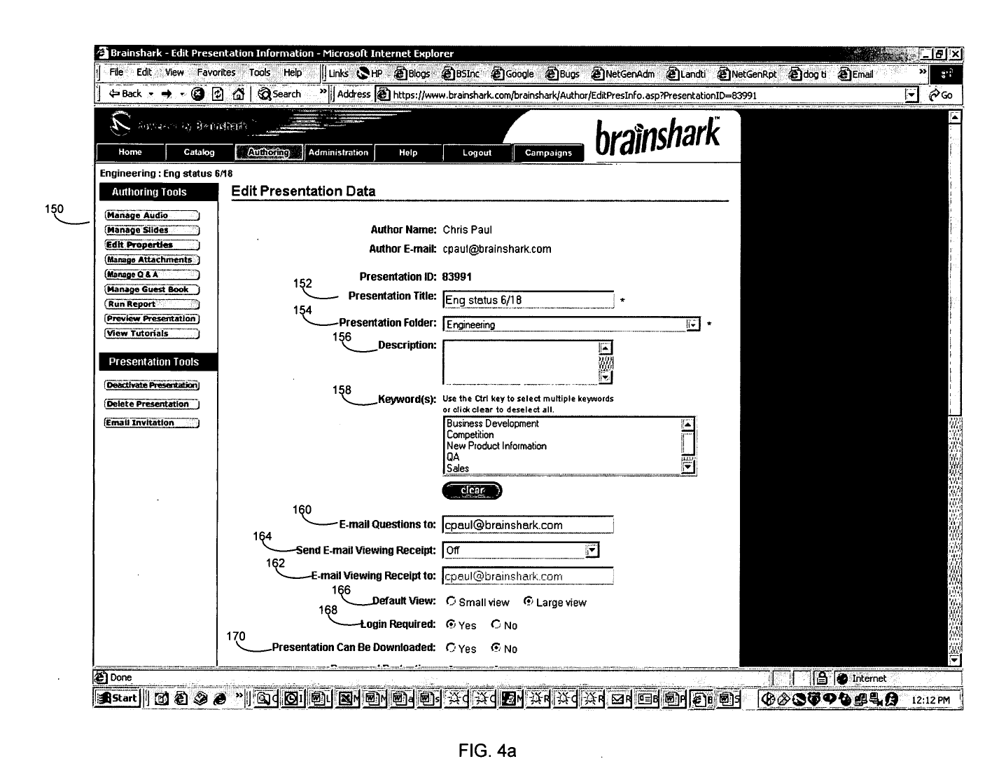

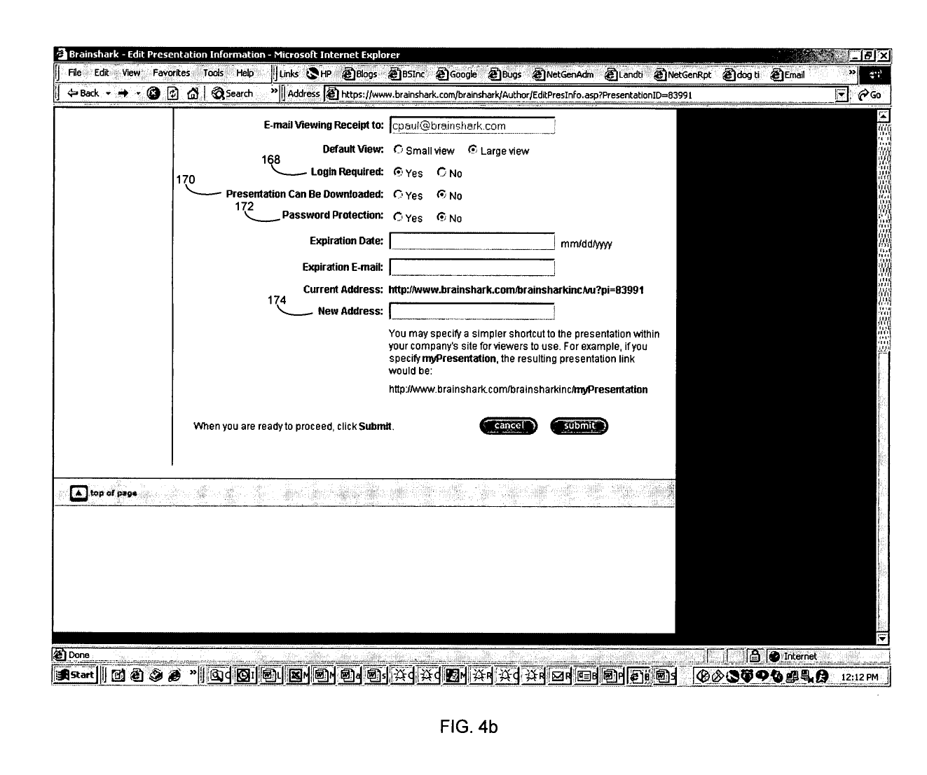

Referring also to FIGS. 4a & 4b, once presentation slides 58 are uploaded 104 to host server 12 and converted 106 into graphic image files 60, user 56 may modify 108 various properties of the presentation (using the “Edit Presentation Data” screen 150), such as: the presentation title 152 (which is indexed and searchable); the presentation folder 154 (which identifies the location of the presentation as well as helps to define the security permissions for the presentation); the free text description 156 (which is indexed and searchable); keywords 158 (which are indexed an searchable); the viewer question e-mail address 160; the viewing receipt e-mail address 162 (which enables an automatic e-mail to the specified e-mail address when the presentation is viewed); the email receipt request 164; the default view 166 (determines whether the host server 12 by default uses small or large slide images on playback); the presentation security level 168 (i.e., levels may include public (accessible to anyone with the URL) and private (requires user name and password)); whether the presentation is downloadable 170; whether the presentation is password protected 172 (i.e., an additional password required by viewers in order to view the presentation); and the substitute URL 174.

Referring again to FIG. 3, in order to add audio to the uploaded presentation slides, user 56 establishes 110 a voice connection between telephone 52 and host system 12 via public switched telephone network 54. Alternatively, telephone 52 may be a wireless telephone (e.g., a cellular telephone) that is wirelessly coupled to host system 12. Host system 12 typically includes IVR system 62 (e.g., Dialogic™ IVR systems), which is configured to receive audio (i.e., speech) input from user 56 and provide speech-based audio instructions to user 56. IVR system 62 typically includes hardware and software that enables it to respond to input received from user 56 via the touch pad (not shown) of telephone 52 and to record audio input from user 56. Once a voice connection is established, user 56 records 112 audio narration clips 64 for one or more of the graphic image files 60, each of which represents a slide to be included in the presentation 66.

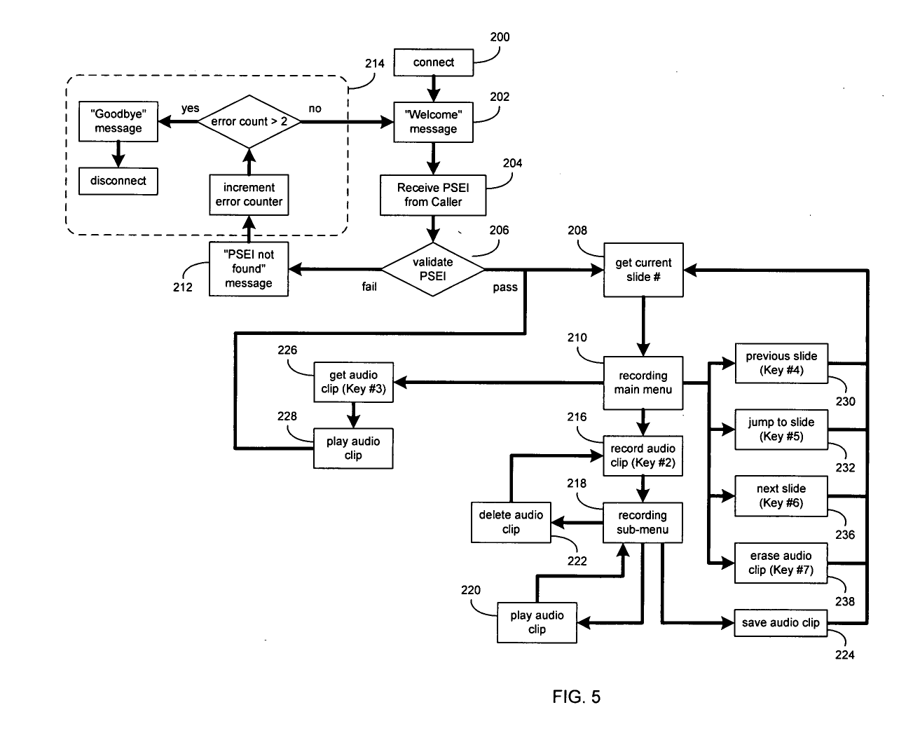

Referring also to FIG. 5, the detail and subprocesses of one embodiment of recording 112 the audio narration clips 64 for the graphic image files 60 of presentation 66 is shown. Continuing with the above-stated example, once user 56 is connected 200 to the IVR 62, IVR 62 plays 202 a “Welcome” message to user 56 and prompts user 56 to input 204 the PESI, thus insuring that user 56 is accessing the proper presentation and providing host system 12 with the information required to retrieve the appropriate graphic image files 60

Once the PESI is validated 206, system 10 accesses 208 the first slide (i.e., Slide # 1) of the presentation, and the recording main menu is provided 210 to user 56 (via speech-based instructions broadcast by IVR 62).

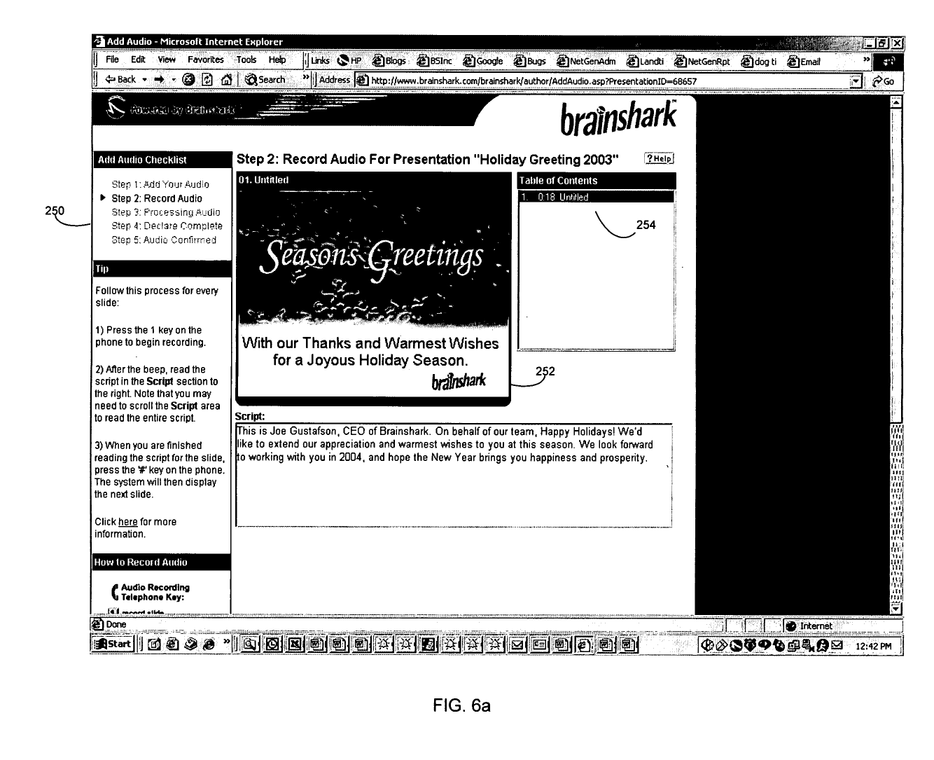

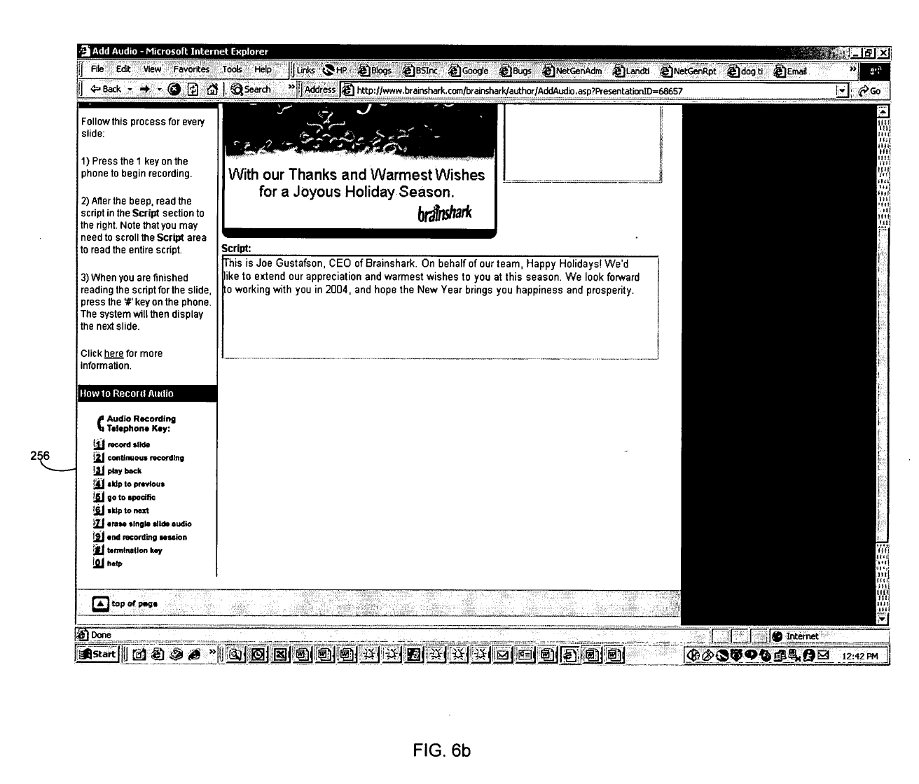

Referring also to FIGS. 6a & 6b, host system 12 also transmits an audio recording screen 250 to user 56 that displays the current slide (as well as other information) on computer 50. Audio recording screen 250 includes a slide window 252 for displaying the current slide for which an audio narration clip is being recorded, a contents window 254 in which the title of each slide within the slideshow presentation 66 is displayed, and an IVR navigation window 256 that illustrates how each key of the keypad of telephone 52 may be used to navigate through an audio narration file recording session.

If host system 12 determines 206 that the PESI entered by user 56 is not valid, a “Not Found” message is transmitted 212 to user 56 through IVR system 62, and IVR system 62 enters a loop 214 that prompts user 56 to reenter the PESI. The login session is terminated if user 56 fails to enter a valid PESI within an administrator-definable number of times (e.g., three times).

Once the PESI is validated 206, Slide #1 of slideshow presentation 66 is accessed 208 by host system 12, and the recording main menu is played 210 for user 56, informing user 56 of the function of each key of the keypad of telephone 52. As shown in IVR navigation window 256, the function of the keys of the touch tone keypad are as follows: Key #1 initiates the audio recording process for the current slide; Key #2 initiates the recording of audio for the current slide and all subsequent slides; Key #3 plays the audio narration clip for the current slide; Key #4 enables user 56 to jump backward one slide in the presentation; Key #5 enables user 56 to jump to a specific slide in the presentation; Key #6 enables user 56 to jump forward one slide in the presentation; Key #7 enables user 56 to erase the audio narration files for a single slide in the presentation; Key #9 enables user 56 to save the presentation and end the audio recording session; and the pound (i.e., #) key enables user 56 to end the recording session for the current slide.

Referring again to FIG. 5, user 56 is presented 210 with the recording main menu, and host system 12 transmits the graphic image file of Slide #1 to composer system 16a to be viewed by user 56. By then pressing Key#1, user 56 is able to record 216 the first audio narration clip to be associated with Slide #1. The audio narration clip is recorded 216 by host system 12 as user 56 speaks into telephone 32. When user 56 has completed the audio narration clip for Slide #1, user 56 may press the pound key to end the recording process for the current slide. Upon pressing the pound key, user 56 is presented 218 with a recording sub-menu (similar to the recording main menu) that enables user 56 to choose further functions by pressing certain keys of the telephone keypad. From the recording sub-menu, user 56 may choose to play 220 the recorded audio narration clip, in which case the audio narration clip is played by the host system 12 through IVR 62 and telephone 32. After listening to the audio narration clip, user 56 may choose to rerecord the audio narration clip, in which case the previously recorded clip is deleted 222, and system 10 allows user 56 to record 216 another audio narration clip for the slide.

Once user 56 is satisfied with the recorded audio narration clip, user 56 can choose to save 224 the audio narration clip (this happens automatically when the user either hangs up the phone or presses Key #9) in e.g., VOX format and subsequently convert the clip to a streaming format (e.g., Real™ Audio, Microsoft™ Media Player, or Macromedia™ Flash™ formats) once user 56 has completed the recording process. The completed audio narration clip is then stored on host system 12. When an audio narration clip is recorded for a slide, the audio narration clip is synchronized 114 with the slide, and saved 116 with its associated slide on host system 12.

At this point, IVR 62 typically returns to the recording main menu, and user 56 is allowed to select the next function from the recording main menu. If user 56 presses Key #3 (i.e., play the audio narration file for the current slide), the audio narration file for the current slide is retrieved 226 from database 68 and played 228. If user 56 presses Key #4 (i.e., jump backward one slide in the presentation), the system retrieves 230 the previous slide (i.e., assuming that the current slide is not the first slide) and transmits the graphic image file of the previous slide to computer 50 for viewing by user 56. Selecting Key #5 (i.e., jump to a specific slide in the presentation) enables user 56 to retrieve 232 a specific slide within the presentation (which is chosen by pressing the appropriate number on the keypad). Further, if User 56 presses Key #6 (i.e., jump forward one slide in the presentation), the system retrieves 236 the next slide in the presentation and transmits the graphic image file of the slide to the computer 50 for viewing by user 56. Selecting Key#7 (i.e., erase the audio narration file for a slide) enables user 56 to erase 238 the audio narration file for a specific slide within the presentation. Once user 56 has completed the audio narration clip recording process, user 56 may select Key #9 from the main recording menu.

In addition to presentation slides and audio narration clips, user 56 may upload addition information files to attach to the presentation. As described above, these files can include Acrobat™, Word™, Excel™, or Visio™, for example. These files may be uploaded by user 56 to provide additional information to the viewer 34, who is able to access and download the files using e.g., viewer system 14a.

While system 10 is described above as if user 56 creates both the presentation slides and the audio narration clips for each slide, other configurations are possible. For example, system 10 may be configured to allow for guest authoring, in which e.g., a first person creates and uploads the slides, and a second person dictates the audio narration clips.

Typically, whenever a slide is displayed, the audio narration clip associated with that slide is played in its entirety. Additionally, it is possible to trigger an event at various points within an audio narration clip. For example, if a slide contains an animation (e.g., the sequential displaying of bulleted items), it is possible to time the displaying of the individual bulleted items based on the playback position of the audio narration clip, such that e.g., at a certain point within the audio narration clip, a bulleted item associated with that point is displayed.

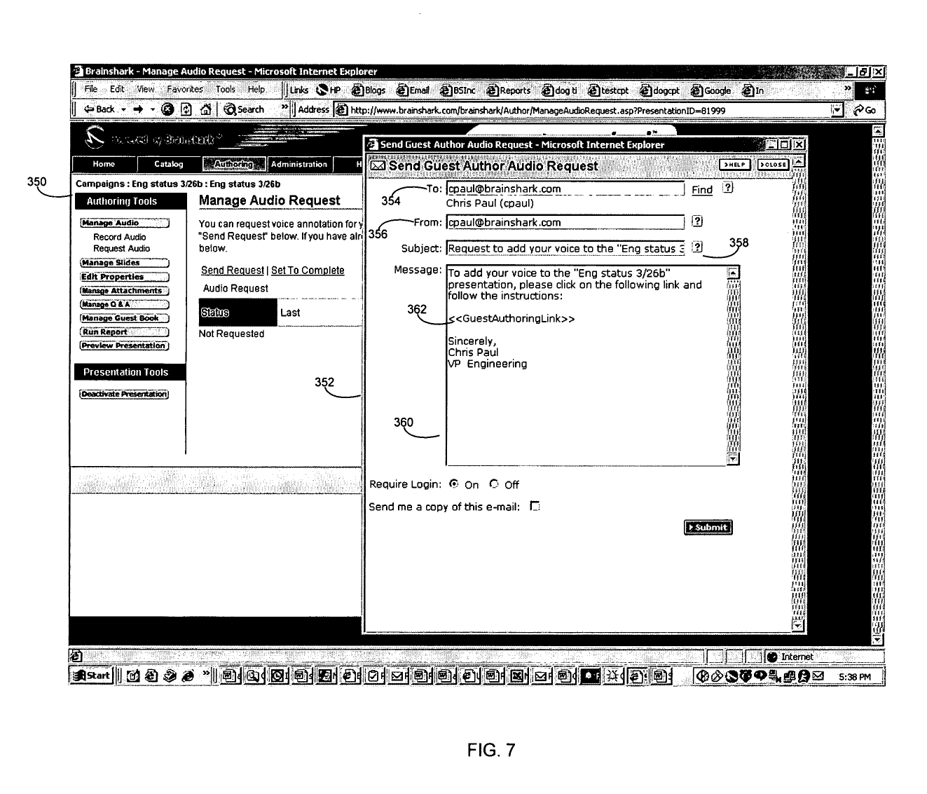

Referring also to FIG. 7, a “Send Guest Author Audio Request” screen 350 is shown. As stated above, when using the guest authoring feature of system 10, once user 56 finishes uploading 104 the presentation slides and modifying 108 the image properties, the presentation slides are stored within database 68. Since user 56 did not yet record any audio narration clips, none of the slides included in this presentation have any audio narration clips associated with them. Since (as described above) only a telephone is required to associate audio narration clips with presentation slides, no specialized equipment is required to narrate a presentation. Accordingly, the guest authoring feature is convenient, as it allows audio is to be easily added (via a standard telephone) by a person who, for example, lacks the requisite computer skill (e.g., the ability to configure a computer-based microphone) or specialized equipment (e.g., a computer capable of recording speech) required to prepare the entire presentation.

Continuing with the above-stated example, assuming that user 56 is allowed to delegate tasks to guest authors and further assuming that user 56 is preparing an end-of-fiscal-year corporate report for mid and upper level management, it may be desirable to have the audio narration clips dictated by the CEO of the company or (alternatively) a person who specializes in voice-over work. Accordingly, using guest authoring screen display 350, user 56 may: prepare an email 352 to guest author 36 (FIG. 1) that provides the guest author with the information required for them to gain access to the presentation and add the audio narration clips. Typically, email 352 includes: the email address 354 of the guest author, the email address 356 of the user; a subject line 358; and a message body 360. In the message body of email 352, the information provided (i.e., concerning the presentation for which guest author 36 needs to dictate the audio narration clips) includes the presentation name “Eng status 3/26b” and a hyperlink (i.e., a URL) 362 that typically links the email to a webpage that allows the guest author to narrate the presentation. Additionally, if the presentation is password protected (i.e., requiring a guest author to log into system 10 prior to adding the audio narration clips), email 352 would typically include the required user name(s) and password(s).

Additionally or alternatively, guest author 36 may be allowed/required to perform additional tasks (e.g., upload presentation slides). Accordingly, if guest author 36 is to provide both slides 58 and audio narration clips 64, user 56 may only be required to define the properties and attributes of presentation 66. Examples of these properties and attributes include: the presentation name; the presentation keywords; whether a view receipt email is sent and to whom; whether a viewer is required to login; whether the presentation is password protected; whether the presentation is downloadable; the expiration date of the presentation; the availability of attachments (i.e., supplemental files); the availability of a guest book; and the availability of a FAQ section. Guest author 36 would then perform the reminder of the tasks associated with preparing the presentation, e.g., upload the required number of slides and provide audio narration clips for each slide.

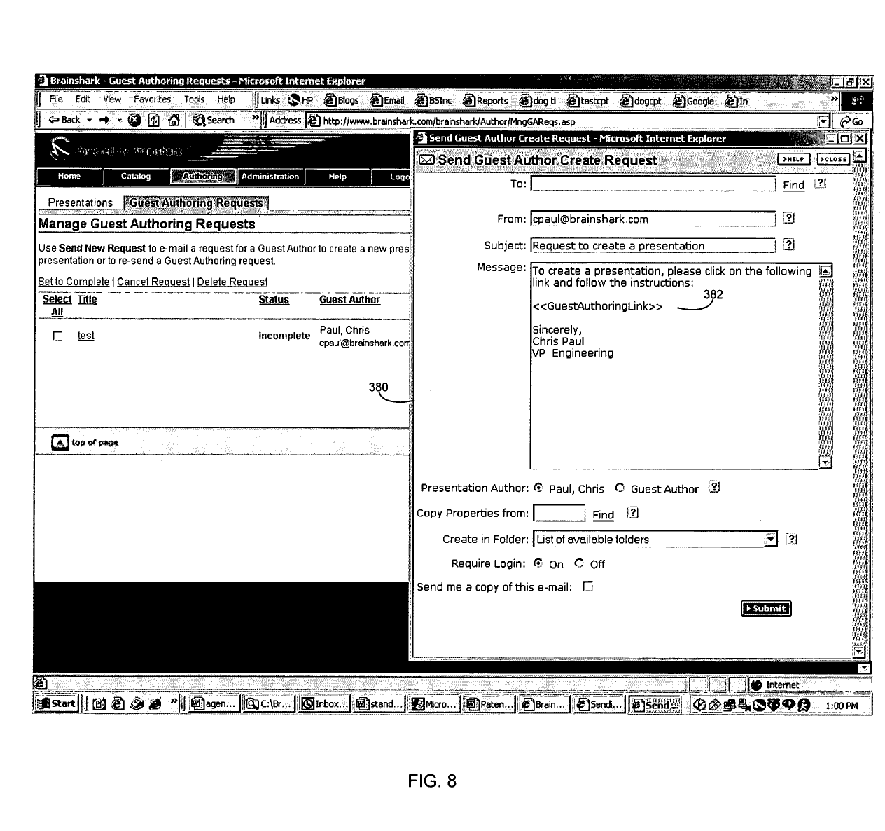

One or more additional guest authors may be used to author various portions of the presentation. For example, a first guest author may upload the required number of slides and a second guest author may provide audio narration clips for each slide. Referring also to FIG. 8, there is shown an example of an email 380 (authored by user 56) that instructs a guest author (i.e., either guest author 36 or a supplemental guest author, not shown) to create a presentation (i.e., upload slides). Typically, any email produced by user 56 includes a URL 382 that is linked to the webpage at which the recipient of the email (i.e., guest author 36) can perform the requested service. For example, as email 380 requests that guest author 36 upload slides, URL 382 provides a link to the webpage that allows guest author 36 to upload slides.

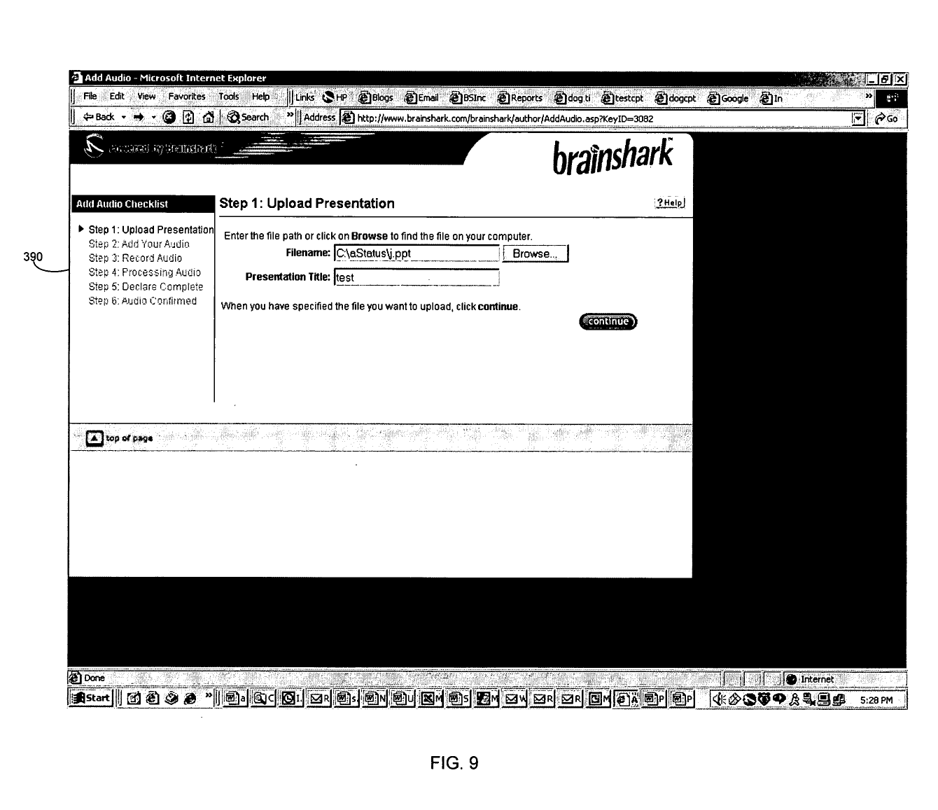

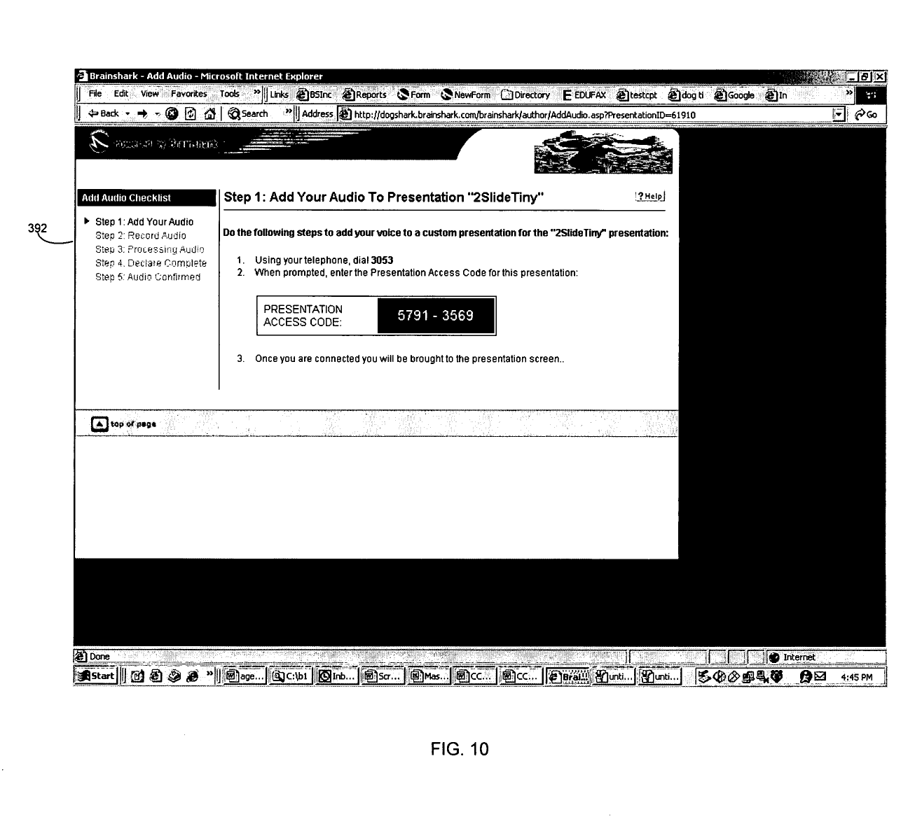

As stated above, the email (i.e., either the email requesting that the guest author upload slides or add audio narration clips) received by guest author 36 typically includes a URL pointing to the webpage at which the guest author can perform the desired task (e.g., upload the slides and/or add the audio narration clips). When the guest author clicks on (i.e., executes) this link, the guest author is taken to e.g., a webpage (e.g., webpage 390, FIG. 9) that allows guest author 36 to locate a local slide file for uploading or a webpage (e.g., webpage 392, FIG. 10) that provides guest author 36 with the information required to add the audio narration clips. Once accessed, webpages 390, 392 allow guest author 36 to upload slides and/or record audio narration clips in a manner essentially the same as that employed by user 56 (as described above).

When utilizing a guest author (e.g., guest author 36), user 56 may restrict the use of the guest author to a distinct portion of a presentation. For example, for various legal and strategic reasons, assume that the mangers of a corporation require that all presentations shown to potential clients of the corporation include boilerplate core information that cannot be modified. Unfortunately, standardized presentations are usually not as effective as personalized presentations. Accordingly, when preparing a presentation, user 56 may allow a guest author (e.g., the leader of a sales team) to personalize (i.e., modify) one or more portions of the presentation, while prohibiting any modifications to the “boilerplate core information”.

When preparing a presentation, the presentation may be broken-down into components or portions. For example, the first portion of the presentation (e.g., the first two slides) may be considered the introduction portion, the core portion of the presentation may be the “boilerplate core information”, and the last portion of the presentation (e.g., the last two slides) may be considered the conclusion portion. Therefore, when configuring a presentation, the guest author may be allowed to personalize the introduction portion (e.g., add the logo of the potential client, for example) and the conclusion portion (e.g., add sales bios, contact information, and photographs, for example.). However, the guest author will not be allowed to modify the core portion (i.e., the “boilerplate core information”) of the presentation. When personalizing presentation 66, guest author 36 may e.g., add audio narration clips and/or upload slides. However, as discussed above, user 56 ultimately controls which, if any, tasks (e.g., uploading slides, adding audio narration clips, etc.) are performed by guest author 36. For example, user 56 may allow guest author 36 to upload the first two and the last two slides of a presentation. Additionally, guest author 36 may be allowed to provide audio narration clips for the entire presentation. Further, user 56 may provide “default” audio narration clips for each slide in the presentation, such that the guest author has the option to overwrite one or more of these “default” audio narration clips and provide a replacement audio narration clip.

Accordingly, when using guest authors, system 100 enables user 56 to allow a guest author to: perform a narrow task for an entire presentation (e.g., adding audio narration clips to each presentation slide within a presentation), perform broader tasks for one or more portions of a presentation (e.g., adding audio narration clips and uploading slides for the introduction and conclusion portions of a presentation), or somewhere in between.

When user 56 utilizes a guest author to generate a portion (e.g., an introduction portion of a presentation, a slide, audio narration clips, etc.), user 56 may wish to verify the quality/accuracy of the work performed by the guest author prior to the presentation being made available for viewing. Accordingly, once a guest author has completed the tasks assigned to them, user 56 may be notified so that the user can review and authorize the presentation prior to making the presentation available to third parties. This approval process may simply allow the user to either accept or reject the presentation. Alternatively, user 56 may be allowed to amend the guest author's work (e.g., overwrite various audio narration clips, delete uploaded slides, etc.).

System 10 may also be used by user 56 to manage presentation campaigns. Continuing with the above-stated example, when preparing the presentation discussed above that includes an introduction portion, a core portion, and a conclusion portion, assume that instead of preparing the presentation for one sales team, the presentation is being prepared for thirty sales teams. Accordingly, it is probable that thirty unique presentations would need to be generated, with the core portion (i.e., the uneditable portion) prepared by user 56 and the introduction and conclusion portions prepared by guest authors specifically for each sales team. These guest authors may be e.g., the leader of each sales team or a graphics/voice subcontractor. Accordingly, user 56 may use system 10 to request guest authoring services from (in this example) thirty guest authors, such that each guest author generates the unique introduction and conclusion portion of their sale team's presentation. Each of these unique introduction/conclusion presentation portions are then combined with the generic “core” portion to form thirty unique presentation (i.e., one for each sales team). When preparing a campaign, user 56 may quickly create unique presentations by simply inserting identifying information concerning the sales team for which the presentation is prepared. For example, user 56 may simply insert (into the unique introduction/conclusion presentation portions of the presentation) information that identifies e.g., the name, address and telephone number of the sales team supervisor.

In order to aid in the distribution of presentations, user 56 may maintain a distribution list (e.g., an email distribution list) on database 68 of system 10 so that any presentations generated for a campaign may be distributed to potential clients as an email attachment or a embedded URL locating the online presentation. Alternatively, the distribution list may be maintained and provided by a client and system 10 may modify the distribution list (e.g., to include the URL locating the online presentation), which is provided back to the client so that the client or third party (e.g., an email distribution house) can distribute presentations. Typically, the URL locates the online presentation that was customized e.g., by the sales representative responsible for the recipient of the online presentation. Additionally, the URL may also include a unique identifier that allows the recipient's interest in the online presentation to be gauged, by monitoring e.g., the amount of time that the user spent reviewing the entire presentation, the number of slides reviewed within the presentation, and the amount of time spent on each slide of the presentation.

Typically, when preparing a campaign, the campaign manager is typically responsible for managing the entire campaign process and is trained to know the product. The campaign manager is typically responsible for: managing the presentation; preparing/uploading one or more portions of the presentation; sending out audio narration requests to senders (e.g., sales representatives) and experts (e.g., voice-over people or CEO's); merging content to create the presentation; and generating the distribution list(s), for example. The expert is typically a high-profile individual (e.g., a CEO, financial consultant, actor, or voice-over professional, for example) who is responsible for recording the audio narration clips for the core portion of the online presentation. Due to the structure and configuration of system 10, the expert need not be highly computer proficient. The senders (e.g., the sales representative(s) responsible for the recipient(s) of the online presentation) are typically responsible for preparing the graphics and/or audio narration clips of the introduction and conclusion portions of the online presentation.

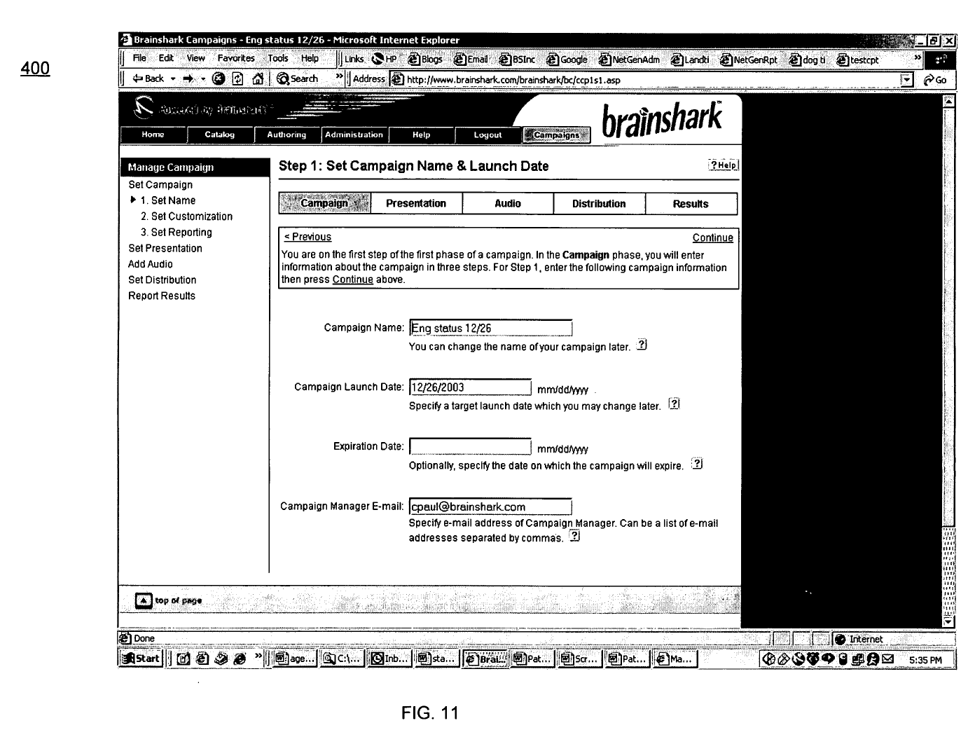

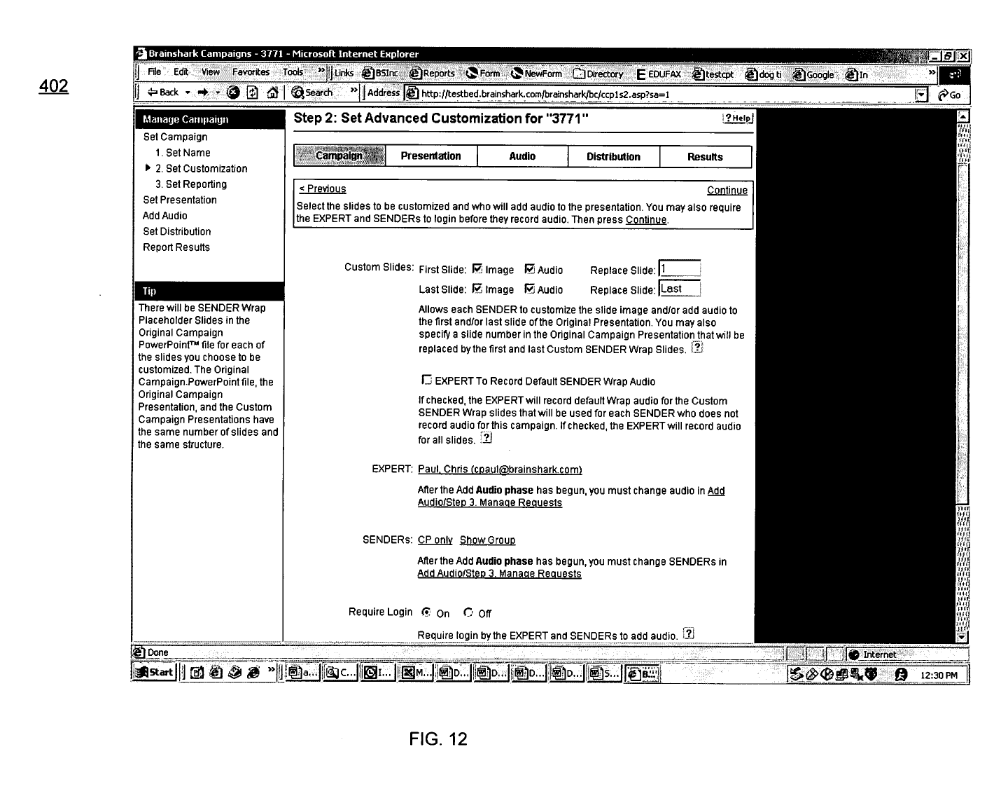

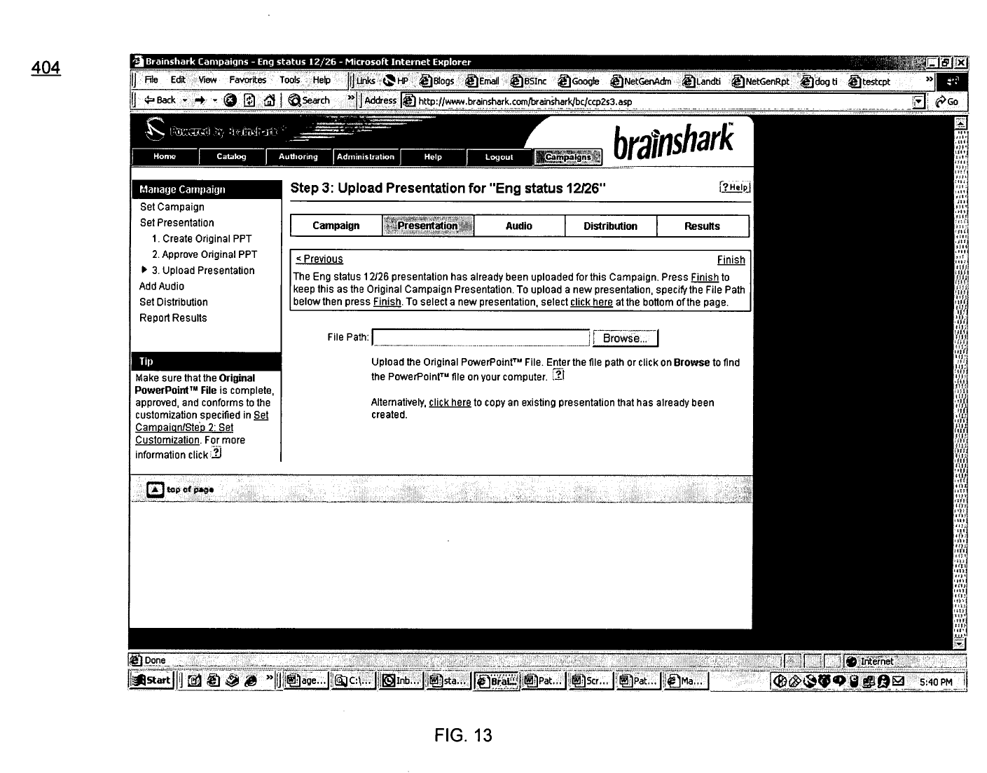

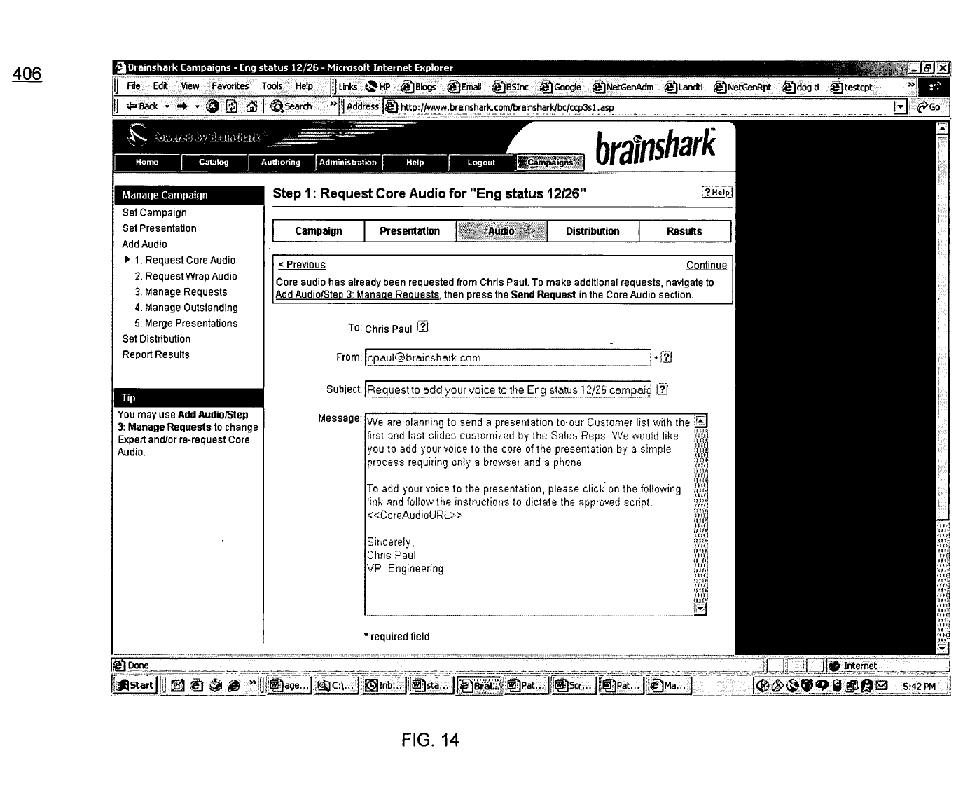

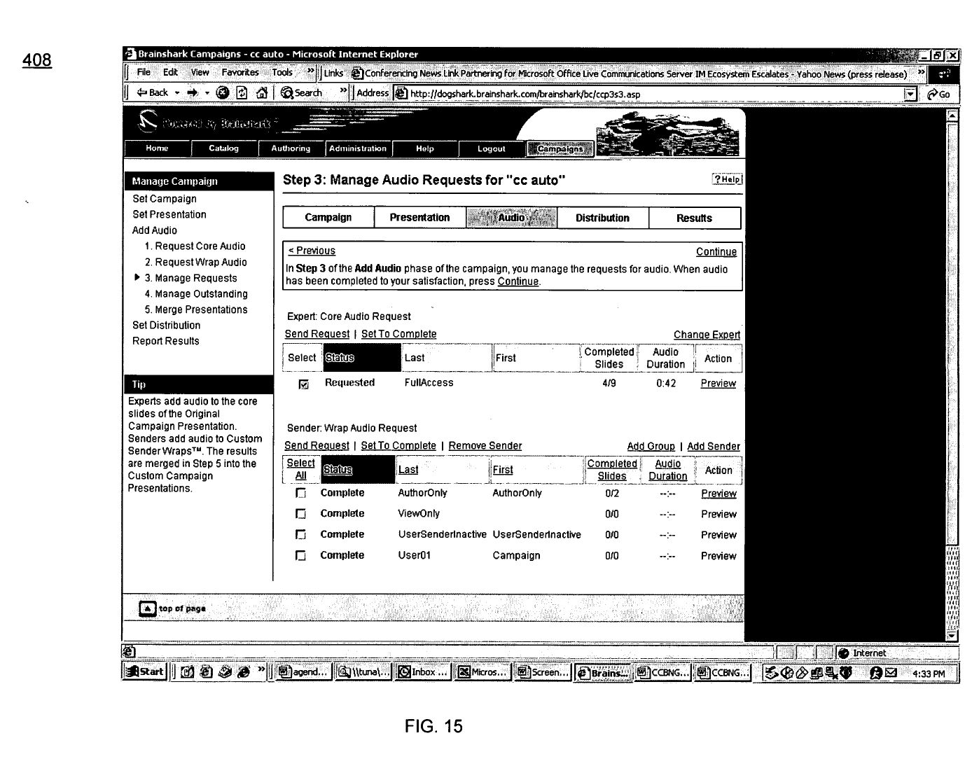

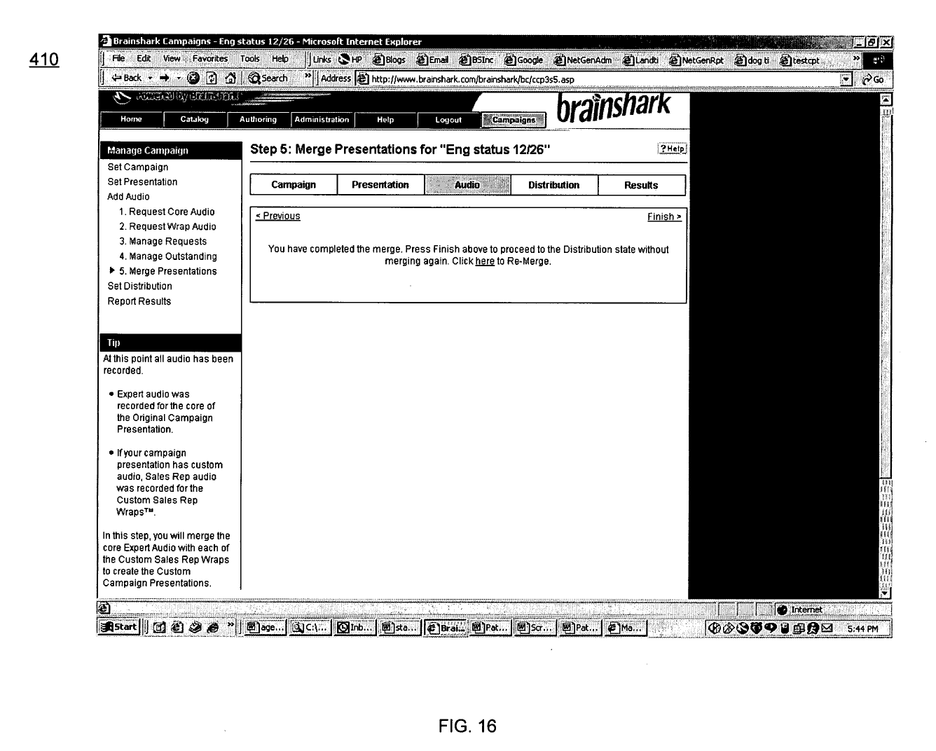

When preparing a campaign, a “Set Campaign Name and Launch Date” screen 400 (FIG. 11) allows user 56 (e.g., the campaign manager) to define various campaign attributes, such as: the campaign name; the campaign launch date; the campaign expiration date; and the campaign manager email. A “Set Advanced Customization” screen 402 (FIG. 12) allows user 56 to further define the campaign, including e.g., which slides of the presentation may be customized, the user (i.e., the campaign manager), the senders (i.e., sales managers, or salesman, for example). Once the campaign is defined, an “Upload Presentation” screen 404 (FIG. 13) allows user 56 to upload the “core portion” of the presentation. User 56 may request that a guest author (e.g., an expert) provide audio narration clips for the core portion of the presentation using a “Request Core Audio” screen 406 (FIG. 14). A similar screen (not shown) may be used by user 56 to request that other guest authors (e.g., senders) provide audio narration clips for the introduction and conclusion portions of each of the unique presentations. Once audio requests (i.e., core audio, introduction audio, and/or conclusion audio) are made, user 56 may monitor the status of these requests and reiterate requests using the “Manage Audio Requests” screen 408 (FIG. 15). Once all audio requests are satisfied, user 56 may generate the campaign using the “Merge Presentations” screen 410 (FIG. 16), which generates each of the unique online presentations by combining the common presentation slides (typically prepared by user 56) with the common core audio narration clip(s) (typically prepared by the expert) and the custom introduction and conclusion audio narration clips (typically prepared by the sender(s)), thus resulting in a plurality of unique online presentations.

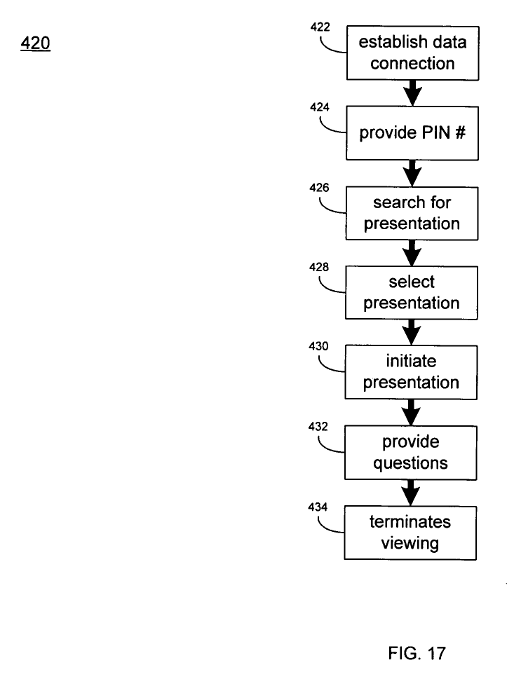

Referring also to FIGS. 17 & 18, there is shown a method 420 for viewing presentation 66. When viewer 34 wishes to view a presentation, a data connection between e.g., viewer system 14a and host system 12 is established 422 via network 22. If the presentation is not a public presentation, the viewer may be required to provide 424 (via viewer system 14a) a personal identification number (PIN) number to host system 12 that grants access to the presentation. Once the viewer's PIN has been approved, host system 12 transmits a presentation viewing screen 450 to e.g., viewer system 14a. Depending on the PIN submitted, viewer 34 may be presented with a catalog of presentations available for viewing, or only a single presentation. Viewer 34 may (via viewer system 14a) initiate 426 a search for the desired presentation. This search may be performed by performing a text-based search, or by browsing through a catalog of presentation folders.

When the desired presentation is located, viewer 34 may select 428 the presentation for viewing. Once selected, host system 12 retrieves the first slide of the presentation and displays it in slide display window 452 and retrieves the audio narration clip associated with the first slide of the presentation. Host system 12 also lists the name of each slide (in the presentation) and the duration of the associated audio narration clip in the contents window 454. The name of each slide is in the form of a link that enables viewer 34 to select and directly access individual slides for viewing. Once the presentation is retrieved, viewer system 16a automatically initiates 430 the presentation by instructing host system 12 to begin playing the audio narration clip for the first slide. Viewer 34 is able to navigate through the presentation using the presentation navigation buttons 456, which enable viewer 34 to pause the presentation, repeat the presentation, and skip between slides of the presentation.

When viewer 34 instructs host system 12 to play the presentation, host system 12 plays the audio narration clip for the first slide in the presentation. As set forth above, the audio narration clips are typically encoded into a Real™ Audio, Microsoft™ Media Player™, or Macromedia™ Flash™ format or into a telephone-playback format. Prior to viewing, the viewer has the option to either: preloading all the slide images (i.e., for efficient delivery on low bandwidth connections); or loading slides on an ad hoc basis (i.e., at the rate in which viewer 34 views the presentation). Once the audio clip for the first slide is completed, the next slide in the presentation (and its associated audio narration clip) are retrieved from database 68 by host system 12 and transmitted to viewer system 14a for playing. This process is repeated until either the presentation ends or the viewer pauses/stops the presentation using presentation navigation buttons 456. Additionally, viewer 34 may navigate forward and backward within a single audio narration clip by using slider control 458.

If viewer 34 has a question about the presentation they are watching, viewer 34 (via Q&A tab 460) may access a page that enables viewer 34 to send 432 a question to user 56 (i.e., the composer of the presentation) or view the FAQs (i.e., frequently asked questions) that have been posted and answered by user 56. For example, viewer 34 may be able to send a text-based question (via email) to user 56. Once the presentation is complete, viewer 34 may terminate 434 their viewing of the presentation.

Host system 12 typically includes security features that prevent unauthorized access to the presentations stored within database 68. For example and as stated above, system 10 includes a system administration system 18 and a company administration system 20. System administration system 18 allows for e.g., the creation and deletion of company accounts, and company administration system 20 allows for e.g., the creation and deletion of individual accounts within a company account. Further, company administration system 20 may create an individual account for each of its employees and assign unique privileges to each account (e.g., certain people within the company may only be allowed to view presentations and not compose them). Other methods of regulating access include: configuring one or more folder categories so that only certain employees within a company have access to the presentations within these folder categories; only allowing access to certain presentations by those viewer systems having an IP (i.e., internet protocol) address within a certain range of IP addresses; and only allowing access to certain presentations if the viewer gained access to the host system site through a link from an approved referral site.

Another feature of host system 12 is the ability to track various activities within the system and provide usage reports to system administration system 18 and the company administration system 20, thus allowing for: accurate usage billing; efficient security monitoring; accurate planning of future system expansion(s); assurance that required presentations are being viewed, and accurate determination of the amount that each presentation is being viewed, for example. For example, when viewer 34 views an online presentation, the campaign manager and/or the sender may be notified that the viewer viewed the presentation. This notification may include providing the campaign manager and/or the sender with an interest level indicator indicative of the interest level displayed by the recipient of the presentation, such that the interest level indicator indicates e.g., the amount of time spent viewing the entire presentation, the amount time spent viewing each slide of the presentation, the time at which the presentation was initially viewed, and the total number of slides viewed, for example.

Host system 12 is capable of generating the following reports: Presentation Information Reports; Presentation Viewing Reports; Presentation Summary Reports; Composer Summary Reports; Viewer Summary Reports; and Viewer Detail Reports, which may be generated on screen or exported to a comma separated value (CSV) file, an HTML file, a Microsoft™ Excel™ file, and an Adobe™ Acrobat™ file.

Presentation Information Reports may include: the date and time that the presentation was created; the presentation identification number; the presentation title; the presentation author; the total duration of the presentation; the total IVR session time for all composition and editing sessions; and the total file size of the presentation and all supporting materials.

Presentation Viewing Reports may include: the identification of parties who viewed the presentation; the dates and times the presentation was viewed; the total time that the presentation was viewed; and the number of slides viewed.

Presentation Summary Reports may include: the total number of presentations created; the total number of hours of content created; and the total size of files uploaded.

Composer Summary Reports may include: the presentation identification numbers; the presentation titles; the date the presentations were created; the duration of the presentations; and the total IVR session time for all authoring and editing sessions.

Viewer Summary Reports may include: the total number of viewers accessing presentations.

Viewer Detail Reports may include: the presentation identification numbers; the presentation titles; the duration of the viewing sessions; and the number of slides viewed.

A number of implementations have been described. Nevertheless, it will be understood that various modifications may be made. Accordingly, other implementations are within the scope of the following claims.

1. An online presentation authoring method comprising:
allowing a primary author to perform a primary set of tasks concerning an online presentation; and
requesting that a guest author perform a secondary set of tasks concerning the online presentation;
wherein the guest author is prohibited from performing a portion of the primary set of tasks concerning the online presentation.

2. The online presentation authoring method of claim 1 wherein the guest author includes two or more guest authors, and requesting that a guest author perform a secondary set of tasks includes:
requesting that a first guest author perform a first portion of the secondary set of tasks; and
requesting that a second guest author perform a second portion of the secondary set of tasks;
wherein the first guest author is further prohibited from performing a portion of the second portion of the secondary set of tasks, and the second guest author is further prohibited from performing a portion of the first portion of the secondary set of tasks.

3. The online presentation authoring method of claim 1 further comprising:
authoring a message inviting the guest author to perform the secondary set of tasks.

4. The online presentation authoring method of claim 3 wherein:
the message is an email.

5. The online presentation authoring method of claim 3 wherein:
the message includes a link that directs the guest author to a screen display that facilitates the guest author completing the secondary set of tasks.

6. The online presentation authoring method of claim 5 wherein the secondary set of tasks includes uploading one or more presentation files, and the link directs the guest author to a screen display that facilitates the guest author uploading the presentation files.

7. The online presentation authoring method of claim 5 wherein the secondary set of tasks includes providing audio narration clips, and the link directs the guest author to a screen display that provides the guest author with pertinent information that facilitates the guest author providing the audio narration clips.

8. The online presentation authoring method of claim 7 further comprising:
allowing the guest author to provide the audio narration clips using a standard telephony device.

9. The online presentation authoring method of claim 1 wherein the guest author completes the secondary set of tasks, the method further comprising:
allowing the primary author to review and/or edit the secondary set of tasks completed by the guest author.

10. The online presentation authoring method of claim 1 wherein the guest author completes the secondary set of tasks, the method further comprising:
requiring the primary author to review and/or approve the secondary set of tasks prior to the online presentation being made available for viewing.

11. The online presentation authoring method of claim 1 further comprising:
granting control of the completed online presentation to the guest author once the secondary set of tasks is completed.

12. The online presentation authoring method of claim 1 further comprising:
regulating whether the primary author can request that the guest author perform the secondary set of tasks.

13. The online presentation authoring method of claim 1 further comprising:
requiring the guest author to provide a username and/or password prior to performing the secondary set of tasks.

14. The online presentation authoring method of claim 1 wherein the primary set of tasks is chosen from the group consisting of: defining a presentation name; defining one or more presentation keywords; defining whether a view receipt email is required; defining whether a viewer of the online presentation is required to provide a username and/or password; defining whether the online presentation is password protected; defining whether the online presentation is downloadable; defining an expiration date for the online presentation; defining the availability of attachments; defining the availability of a guest book; and defining the availability of a FAQ section.

15. A computer program product residing on a computer readable medium having a plurality of instructions stored thereon which, when executed by the processor, cause that processor to:
allow a primary author to perform a primary set of tasks concerning an online presentation; and
request that a guest author perform a secondary set of tasks concerning the online presentation;
wherein the guest author is prohibited from performing a portion of the primary set of tasks concerning the online presentation.

16. The computer program product of claim 15 wherein the guest author includes two or more guest authors, and the instructions for requesting that a guest author perform a secondary set of tasks include instructions for:
requesting that a first guest author perform a first portion of the secondary set of tasks; and
requesting that a second guest author perform a second portion of the secondary set of tasks;
wherein the first guest author is further prohibited from performing a portion of the second portion of the secondary set of tasks, and the second guest author is further prohibited from performing a portion of the first portion of the secondary set of tasks.

17. The computer program product of claim 15 further comprising instructions for:
authoring a message inviting the guest author to perform the secondary set of tasks.

18. The computer program product of claim 17 wherein:
the message is an email.

19. The computer program product of claim 17 wherein:
the message includes a link that directs the guest author to a screen display that facilitates the guest author completing the secondary set of tasks.

20. The computer program product of claim 19 wherein the secondary set of tasks includes uploading one or more presentation files, and the link directs the guest author to a screen display that facilitates the guest author uploading the presentation files.

21. The computer program product of claim 19 wherein the secondary set of tasks includes providing audio narration clips, and the link directs the guest author to a screen display that provides the guest author with pertinent information that facilitates the guest author providing the audio narration clips.

22. The computer program product of claim 21 further comprising instructions for:
allowing the guest author to provide the audio narration clips using a standard telephony device.

23. The computer program product of claim 15 wherein the guest author completes the secondary set of tasks, the computer program product further comprising instructions for:
allowing the primary author to review and/or edit the secondary set of tasks completed by the guest author.

24. The computer program product of claim 15 wherein the guest author completes the secondary set of tasks, the computer program product further comprising instructions for:
requiring the primary author to review and/or approve the secondary set of tasks prior to the online presentation being made available for viewing.

25. The computer program product of claim 15 further comprising instructions for:
granting control of the completed online presentation to the guest author once the secondary set of tasks is completed.

26. The computer program product of claim 15 further comprising instructions for:
regulating whether the primary author can request that the guest author perform the secondary set of tasks.

27. The computer program product of claim 15 further comprising instructions for:
requiring the guest author to provide a username and/or password prior to performing the secondary set of tasks.

28. The computer program product of claim 15 wherein the primary set of tasks is chosen from the group consisting of: defining a presentation name; defining one or more presentation keywords; defining whether a view receipt email is required; defining whether a viewer of the online presentation is required to provide a username and/or password; defining whether the online presentation is password protected; defining whether the online presentation is downloadable; defining an expiration date for the online presentation; defining the availability of attachments; defining the availability of a guest book; and defining the availability of a FAQ section.

29. An online presentation authoring method comprising:
allowing a primary author to generate a primary portion of an online presentation; and
requesting that a guest author generate a secondary portion of the online presentation;
wherein the guest author is prohibited from generating the primary portion of the online presentation.

30. A computer program product residing on a computer readable medium having a plurality of instructions stored thereon which, when executed by the processor, cause that processor to:
allow a primary author to generate a primary portion of an online presentation; and
request that a guest author generate a secondary portion of the online presentation;
wherein the guest author is prohibited from generating the primary portion of the online presentation.
